(19) United States
(12) Patent Application Publication
(10) Pub. No.: US 2006/0068054 A1
(43) Pub. Date: Mar. 30, 2006

(54) Technique for high-speed TDF testing on low cost testers using on-chip or off-chip circuitry for RapidChip and ASIC devices

(76) Inventors: Kevin Gearhardt, Fort Collins, CO (US); Richard Schultz, Fort Collins, CO (US)

Correspondence Address: LSI LOGIC CORPORATION, 1621 BARBER LANE, MS: D-106, MILPITAS, CA, 95035, US

(21) Appl. No.: 10/954,939

(22) Filed: Sep. 30, 2004

(51) Int. Cl. B29C 43/48

(52) U.S. Cl. 425/371

(57) ABSTRACT

TDF testing has become a requirement for any and all product applications for which product quality is of utmost concern, e.g. storage components. The specific problem with regard to TDF testing is that most production test systems cannot exceed a 200 Mhz effective TDF test rate. A higher speed solution for use with existing tester platforms is provided, without having to spend significant capital resources to upgrade to newer tester platforms. One solution adds circuitry to the test hardware used to interface to the DUT. Another solution adds circuitry to the actual design prior to releasing it for processing.

### BACKGROUND

The present invention relates to production test requirement for timing delay fault (TDF) testing for RapidChip and ASIC devices.

Traditional stuck-at fault testing is no longer adequate to meet expectations for product quality levels. As such, TDF testing has become a requirement for any and all product applications for which product quality is of utmost concern, e.g. storage components. The specific problem with regard to TDF testing is that most production test systems cannot exceed a 200 Mhz effective TDF test rate. With 130 nm technology ramping up, and 90 nm technology on the horizon, the 200 Mhz test rate is not adequate to detect TDF-type failures. A higher speed solution is needed on these existing tester platforms, without having to spend significant capital resources to upgrade to newer tester platforms.

The only real existing solution to the aforementioned problem is to purchase newer tester platforms that can support test frequencies well beyond the current 200 Mhz limitation. The capital expenditures required for such a solution are not feasible.

### OBJECTS AND SUMMARY

An object of an embodiment of the present invention is to provide a higher speed solution for use with existing tester-platforms, without having to spend significant capital resources to upgrade to newer tester platforms.

One embodiment of the present invention provides a solution to the aforementioned TDF test problem by adding circuitry to the test hardware used to interface to the device-under-test (DUT). The circuitry consists of a simple XOR gate which is driven by two tester channels. The output of this XOR is then buffered to match the input levels expected by the DUT clock input pin. Multiple XOR gates could be added to the DUT test hardware as needed.

Since this solution can be accomplished with circuitry added to the DUT test hardware, no modifications to the actual silicon design are required. Therefore the solution can be implemented for existing products via redesigning the DUT hardware to accommodate the described solution. The costs associated with the hardware design are nominal, and at a minimum the new test hardware can provide a 400 Mhz launch/capture clock sequence for TDF testing.

Another embodiment of the present invention provides a solution to the aforementioned TDF test problem by adding circuitry to the actual design prior to releasing it for processing. As such it will require only a single clock pulse from the automated test equipment (ATE) in order to be able to generate the necessary high-speed two pulse clock stream required for TDF launch/capture operations. The circuitry consists of a simple XOR gate which is driven by the original clock pulse generated by the ATE and a delayed version of that same clock signal. The output of this XOR is then buffered and supplied to the clock circuit which drives the test logic on the device.

Since the logic to generate the high-speed clock pulses is implemented on the actual device to be tested, the maximum frequency which can be generated is theoretically only limited by the performance of the process technology associated with the design. In practice, the maximum frequency which can be generated will be more than sufficient to provide the needed TDF test coverage.

### BRIEF DESCRIPTION OF THE DRAWINGS

The organization and manner of the structure and operation of the invention, together with further objects and advantages thereof, may best be understood by reference to the following description, taken in connection with the accompanying drawings, wherein:

FIG. 1 illustrates a circuit which is in accordance with a first embodiment of the present invention, wherein circuitry has been added to the test hardware used to interface to the device-under-test (DUT);

FIG. 2 shows values of signals which are related to the circuit shown in FIG. 1;

FIG. 3 illustrates a circuit which is in accordance with a second embodiment of the present invention, wherein circuitry has been added to the DUT;

FIG. 4 shows values of signals which are related to the circuit shown in FIG. 3;

### DESCRIPTION

While the invention may be susceptible to embodiment in different forms, there are shown in the drawings, and herein will be described in detail, specific embodiments of the invention. The present disclosure is to be considered an example of the principles of the invention, and is not intended to limit the invention to that which is illustrated and described herein.

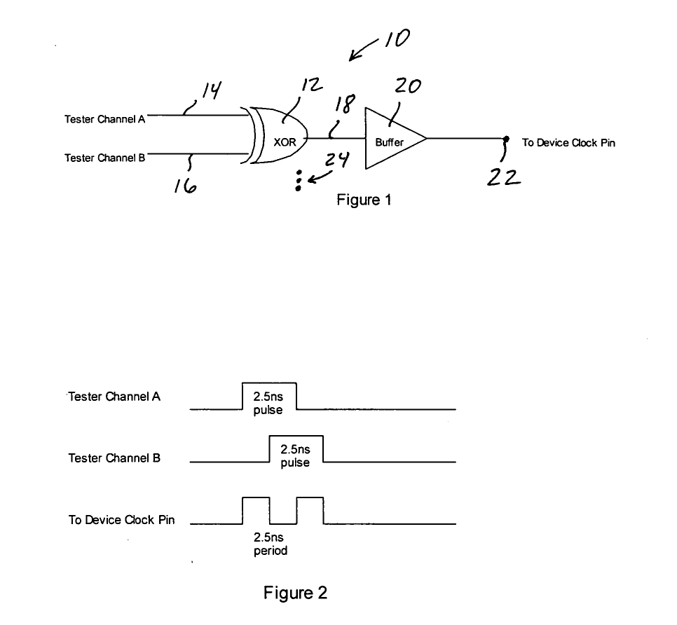

A first embodiment of the present invention provides a solution to the aforementioned TDF test problem by adding circuitry 10 to the test hardware used to interface to the device-under-test (DUT). As shown in FIG. 1, the circuitry 10 consists of an XOR gate 12 which is driven by two tester channels 14 and 16 (i.e., ‘Tester Channel A’ and ‘Tester Channel B’). The output 18 of this XOR 12 is then buffered (via buffer 20) to match the input levels expected by the DUT clock input pin 22. Multiple XOR gates could be added to the DUT test hardware as needed (as represented by dots 24 in FIG. 1).

The high-speed clock signals needed by the DUT to perform the TDF testing are generating by supplying two separate clock pulses (14 and 16 in FIG. 1) at ‘Tester Channel A’ and ‘Tester Channel B’. Those clock pulses are generated 90-degrees out of phase to generate a resultant high speed clock with a 50% duty cycle. FIG. 2 shows the two tester-generated clock signals and the resultant high-speed clock to be sent to the DUT.

For the 200 Mhz maximum frequency tester mentioned hereinabove, the minimum pulse width that can be generated by a given tester channel is 2.5 ns. The XOR circuit 10 shown in FIG. 1 will generate two clock pulses on a single pin from the two pulses supplied by the two tester channels driving the XOR inputs. The “frequency” of the resultant two-pulse clock stream is determined by the minimum pulse width of the signal generated by ‘Tester Channel A’, and the duty cycle of those clock pulses is determined by the phase relationship of ‘Tester Channel B’ to ‘Tester Channel A’. So, for the pulse stream shown in FIG. 2, both ‘Tester Channel A’ and ‘Tester Channel B’ generate 2.5 ns pulses which are 90-degrees out of phase. The resultant output from the XOR/buffer circuit 10 will be two clock pulses with a 1.25 ns pulse width and 2.5 ns effective period. This is equivalent to a 400 Mhz clock pulse sequence, and it is generated by two ‘200 Mhz’ clock pulses.

The primary feature of the first embodiment of the present invention is its ability to provide two consecutive high-speed clock pulses (400 Mhz on a 200 Mhz tester using two tester channels) to be used as launch/capture clocks for TDF testing. The example described hereinabove uses only two tester channels to generate the high-speed clock pulse stream required for the launch/capture sequence required for TDF testing. This could be expanded (as represented by dots 24 in FIG. 1) to use four tester channels and additional XOR gates and control logic to generate a two-pulse output as high as 800 Mhz.

Since the solution according to the first embodiment is accomplished with circuitry 10 added to the DUT test hardware, no modifications to the actual silicon design are required. Therefore, the solution can be implemented for existing products via redesigning the DUT hardware to accommodate the described solution. The costs associated with the hardware design are nominal, and at a minimum the new test hardware can provide a 400 Mhz launch/capture clock sequence for TDF testing.

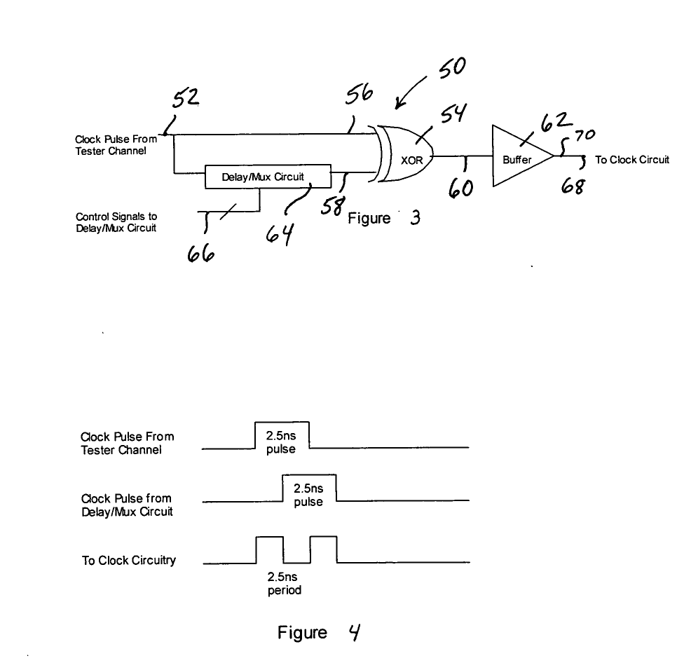

A second embodiment of the present invention provides a solution to the aforementioned TDF test problem by adding circuitry 50 to the actual design prior to releasing it for processing. As such it will require only a single clock pulse 52 from the automated test equipment (ATE) in order to be able to generate the necessary high-speed two pulse clock stream required for TDF launch/capture operations. As shown in FIG. 3, the circuitry 50 consists of an XOR gate 54 which is driven by the original clock pulse generated by the ATE 56 and a delayed version 58 of that same clock signal. The output 60 of this XOR 54 is then buffered (via buffer 62) and supplied to the clock circuit which drives the test logic on the device.

The ‘Delay/Mux Circuit’ 64 (i.e., delay/multiplexer circuit) shown in FIG. 3 receives control signals 66 and is controlled by programming the necessary on-chip test logic such that an appropriately delayed clock pulse 58 derived from the tester's clock pulse 52 is then combined via the XOR gate 54 to generate a high-speed two pulse clock stream used for the launch/capture clocks. Based on the processing of a given device which is known from other on-chip process monitoring circuitry, the delay is set to provide a second pulse which is roughly 90 degrees out of phase from the original signal. FIG. 4 shows the tester-generated clock pulse, the derived/delayed clock pulse, and the resultant high-speed clock used to drive the device.

For the 200 Mhz maximum frequency tester mentioned hereinabove, the minimum pulse width that can be generated by a given tester channel is 2.5 ns. The circuit 50 shown in FIG. 3 will generate two clock pulses on a single pin 68 from the single pulse 52 supplied by the tester channel. The “frequency” of the resultant two-pulse clock stream is determined by the minimum pulse width of the signal generated by ‘Clock Pulse From Tester Channel’, and the duty cycle of those clock pulses is determined by the phase relationship of the delayed version of that signal. So for the pulse stream shown in FIG. 4, the clock pulse generated by the tester comes in with a 2.5 ns pulse width. Its delayed version appears at the input to the XOR approximately 1.25 ns later as selected by the Delay/Mux circuit 64. The resultant output 70 from the circuit 50 will be two clock pulses with a 1.25 ns pulse width and 2.5 ns effective period. This is equivalent to a 400 Mhz clock pulse sequence, and it's generated by a single ‘200 Mhz’ clock pulse supplied by the tester. The ‘Delay/Multiplexer’ circuit 64 can be disabled by the control circuitry which drives it (via signals 66) such that it's output 58 is held low, and the tester generated clock signal 52 is simply passed through the XOR gate 54. This feature would be useful in the event the device required a lower frequency TDF clock pulse stream which could not be accommodated by the Delay/Mux circuit 64.

The primary feature of the second embodiment of the present invention is its ability to provide two consecutive high-speed clock pulses using a single tester channel to be used as launch/capture clocks for TDF testing.

Since the logic to generate the high-speed clock pulses is implemented on the actual device to be tested, the maximum frequency which can be generated is theoretically only limited by the performance of the process technology associated with the design. In practice, the maximum frequency which can be generated will be more than sufficient to provide the needed TDF test coverage. Any test application which requires consecutive high-speed clock pulses could use this approach to testing.

Both solutions discussed hereinabove provide a higher speed solution for use with existing tester platforms, without having to spend significant capital resources to upgrade to newer tester platforms.

While embodiments of the present invention are shown and described, it is envisioned that those skilled in the art may devise various modifications of the present invention without departing from the spirit and scope of the appended claims.

What is claimed is:

1. A circuit configured to be interfaced with a clock pin of a device-under-test, said circuit configured to receive a plurality of clock pulses and provide the clock pulses in a stream to the clock pin of the device-under-test.

2. A circuit as recited in claim 1, wherein the circuit is configured to receive a pair of clock pulses which are 90 degrees out of phase relative to each other.

3. A circuit as recited in claim 1, wherein the circuit comprises an XOR gate which receives said plurality of clock pulses.

4. A circuit as recited in claim 3, wherein the circuit further comprises a buffer which receives an output of the XOR gate and which is configured to be interfaced with the clock pin of the device-under-test.

5. A circuit as recited in claim 4, wherein the circuit is configured such that the buffer outputs a clock signal having a 50% duty cycle

6. A circuit as recited in claim 1, wherein the circuit is configured to provide the stream to the clock pin such that the stream has a frequency defined by a minimum pulse width of one of the clock pulses which are received by the circuit, and a duty cycle defined by a phase relationship of the clock pulses received by the circuit.

7. A circuit which is included on a device-under-test having a clock circuit, said circuit being interfaced with the clock circuit and configured to receive a clock pulse and a delayed version of the clock pulse and provide a clock pulse stream to the clock circuit.

8. A circuit as recited in claim 7, wherein the circuit is configured to receive the clock pulse from Automatic Test Equipment.

9. A circuit as recited in claim 7, wherein the circuit comprises an XOR gate which receives said clock pulse and said delayed version of said clock pulse.

10. A circuit as recited in claim 9, wherein the circuit further comprises a buffer which receives an output of the XOR gate and which is interfaced with the clock circuit.

11. A circuit as recited in claim 7, wherein the circuit further comprises a delay circuit configured to receive the clock signal and output the delayed version of the clock signal.

12. A circuit as recited in claim 11, wherein the delay circuit is configured such that the delayed version of the clock signal is 90 degrees out of phase relative to the clock signal.

13. A circuit as recited in claim 7, wherein the circuit is configured to provide the stream to the clock circuit such that the stream has a frequency defined by a minimum pulse width of the clock pulse which is received by the circuit, and a duty cycle defined by a phase relationship of the clock pulse received by the circuit relative to the delayed version of the clock signal.
